(19) United States
(12) Patent Application Publication
(10) Pub. No.: US 2025/0361663 A1
(43) Pub. Date: Nov. 27, 2025

(54) APPARATUS FOR TREATMENT OF TEXTILES AND USE THEREOF

(71) Applicant: TEXTILE CHANGE APS, Vejle (DK)

(72) Inventors: Simon Hundahl Rossen, Galten (DK); Adriana Sofia Valencia GARCIA, Vejle (DK); Ditte HOJLAND, Vejle (DK); Emma Thonesen HOSTRUP, Aarhus V (DK)

(21) Appl. No.: 18/875,132

(22) PCT Filed: Jun. 22, 2023
(86) PCT No.: PCT/EP2023/066903

§ 371 Date: Dec. 14, 2024

(30) Foreign Application Priority Data
Jun. 23, 2022 (DK) PA202200604

(51) Int. Cl. D06B 9/00; D06B 1/04; D06B 23/16; D06B 23/22

(52) U.S. Cl. CPC D06B 9/00; D06B 1/04; D06B 23/16; D06B 23/22

(57) ABSTRACT

An apparatus for treating a fiber material such as textiles is shown. The fiber material is fed to a reactor volume having an upper and a lower end, and the reactor volume is limited by a first filter in a lower end of the reactor volume and a second filter in the upper end of the reactor volume. A flow of solvent is led through the reactor volume entering the reactor volume through the first filter and exiting the reactor volume through the second filter.

The present invention relates to an apparatus for treating textiles, e.g., by dissolving and extracting dyes and/or textile fibers from other textile fibers, preferably from natural fibers, or e.g., by chemically modifying textile fibers.

### BACKGROUND OF THE INVENTION

Around 85% of all textiles are thrown away, in 2017 it amounted to roughly 13 million tons in US alone. The textile waste is traditionally either dumped into landfill or burned.

Globally, it is estimated that 92 million tons of textile waste are created each year and is equivalent to one rubbish truck filled with clothes ending up on landfill sites every second. By 2030, it is expected that more than 134 million tons of textiles are discarded every year.

Disposal of such large volumes of textile waste is an increasing problem for the apparel industry. The rising costs, reduction in available space, and concern for the environment makes the burning and landfilling of textile waste dwindling options.

Reuse or recycling of the fibers from textiles has been investigated for decades and several methods exists. However, a large percentage of the textile waste comprises blends of fibers such as polyester/cellulosic fabrics, e.g., polyester/cotton and polyester/Tencel™ blends, but also other fibers may be included, such as elastane. The reuse or recycling of the individual blended materials is complicated by the fact that there are inherent differences in the physical properties and composition of the components. Additionally, the fabrics have been treated with resinous materials and other finishing compounds, such as dyes. This makes it nearly impossible to find potential commercial end uses for reused textile material other than rags or cloth scraps, which are of little monetary value.

Therefore, there is an interest in the industry for providing effective recycling of textile waste comprising blends of fibers, such as polyester/cotton fabric blends, which may be reused e.g., in textiles.

Another challenge of reusing textile waste comprising blends of fibers is the presence of dye in the textile. The decolorization of textile waste (pre-and postconsumer) is a huge issue in textile fiber-to-fiber recycling methods, due to a vast number of different dyes and the need to remove them before the textile waste materials can be dissolved and spun into recycled fibers.

When it comes to dyeing fibers, some fibers adhere to and accept dyes easily, while others do not. Depending on the purpose one is seeking to achieve by dyeing the fabric, and the type of dye one is planning to use, very different processes are needed. The dyes are classified by different classification systems, such as chemical classes (e.g., indigoid dyes and azo dyes, such as mono-, di-, and tri-azo dyes) and dye classes (e.g., disperse dyes, vat dyes, insoluble azo dyes, and reactive dyes).

Reactive dyes are extensively used in the dying of cellulosic fabrics, such as cotton. The reactive dye makes a covalent bond with the polymer fiber, thereby becoming an integral part thereof. The term “reactive” is due to this type of dye being the only type of dye that has a reactive group, which reacts chemically with the polymer fiber molecules to form covalent bonds. The use of reactive dyes is increasing. However, one of the challenges with reactive dyes is the subsequent stripping from the fibers during recycling.

Traditionally, it is believed that reactive dye cannot be satisfactorily stripped from the fiber due to the covalent bond between dye molecule and fiber. Since stripping of the dyes including the reactive dyes becomes necessary when textiles are to be reused—a satisfactorily stripping of reactive dyes from the textile fibres is therefore desirable. Hence, it is desirable to provide an apparatus and a process for treating finely divided material such as textile fibers or shredded textiles by e.g., removing dyes or other components from used textiles and thereby increasing the possibilities for re-use.

### SUMMARY OF THE INVENTION

A first aspect relates to an apparatus for treating textile fibers in a solvent suspension comprising a reactor, wherein the reactor comprises:
a lower end and an upper end,
a first filter positioned near the lower end and a second filter positioned near the upper end, the distance between the first filter and the second filter defining a reaction volume for treatment of the textile fibers,
an inlet for solvent positioned below the first filter,
an outlet for solvent positioned above the second filter,
an inlet for fiber material positioned below and normally in proximity of the second filter, and
an outlet for suspended or wetted fiber material positioned above and normally in proximity of the first filter,

where solvent is forced through the reactor from the inlet for solvent to the outlet for solvent, and the fiber material is moved from the inlet for fiber material to the outlet for suspended filter material.

The inventors of the present invention have found that this apparatus is especially suitable for removing dyes from textile. Surprisingly, not only water-soluble dyes, but also water-insoluble dyes may be effectively removed from a textile product with this apparatus. In particular, the apparatus according to the present invention has shown to be extremely effective in removing disperse dyes, insoluble azo dyes, vat dyes, and reactive dyes from a textile product.

This invention makes it possible to decolorize untreated or pre-treated (alkali and/or acid pre-treatments) textile fabrics. Furthermore, natural fibers may be separated from synthetic fibers. Natural fibers may e.g., be produced by plants or algae and may include cellulose and may be provided e.g., as cotton, hemp, sisal, bamboo, viscose, lyocell, or TENCEL™. Synthetic fibers are synthesized in large amounts compared to the separation of natural fibers, but for clothing natural fibers provide benefits, like comfort and water sorption, over their synthetic counterparts.

In one or more embodiments, the apparatus further comprises a solvent pump adapted for pumping solvent to the inlet for solvent, optionally and preferably from a buffer or balance tank.

In one or more embodiments, the apparatus further comprises:
a buffer or balance tank for solvent, and
an inlet for solvent being connected to the outlet for solvent from the reactor by a conduit and being connected to the inlet for solvent by a conduit.

In one or more embodiments, the apparatus further comprises a fiber material feed pump adapted for pumping suspended fiber material to the inlet for suspended fiber material.

In one or more embodiments, the apparatus further comprises a fiber preparation tank having an inlet for dry or wetted fibers and an outlet for suspended or pumpable fiber material.

In one or more embodiments, the apparatus further comprises a separation unit positioned downstream of the outlet for suspended or wetted fiber material, which separation unit separates a fiber rich fraction from a solvent fraction.

In one or more embodiments, either the buffer or the balance tank or the fiber preparation tank has an inlet for re-used solvent connected to the outlet for suspended or wetted fiber material through a conduit. Preferably the conduit is connected to the outlet of a separation unit positioned downstream of the outlet for suspended fiber material.

In one or more embodiments, the apparatus further comprises a heat conditioning unit configured to regulate the temperature of the solvent in the reactor, e.g., to a temperature above ambient temperature, e.g., to a temperature above 50° C., or above 100° C. As an example, the decoloration step may be performed at a different temperature than the step of separating synthetic fibers from natural fibers. In one or more embodiments, the decoloration step is performed at a temperature within the range of 30-120 degrees Celsius, such as within the range of 40-95 degrees Celsius, preferably within the range of 50-90 degrees Celsius, e.g., within the range of 55-85 degrees Celsius, more preferably within the range of 70-90 degrees Celsius, e.g., at a temperature of about 85 degrees Celsius. In one or more embodiments, the fiber separation step is performed at a temperature within the range of 20-180 degrees Celsius, such as within the range of 30-175 degrees Celsius, e.g., within the range of 40-170 degrees Celsius, such as within the range of 50-165 degrees Celsius, e.g., within the range of 60-160 degrees Celsius, preferably within the range of 80-150 degrees Celsius, more preferably within the range of 100-140 degrees Celsius, e.g., at a temperature of about 140 degrees Celsius. The same type of solvent may be used, but at different temperatures.

The apparatus may in one or more embodiments be used in a process for providing a solid polyester fraction from a textile product comprising natural fibers, and polyester fibers, the process comprising the steps of:
(i) proving the textile product comprising natural fibers, and polyester fibers;
(ii) adding a liquid decolorizing agent to the textile product, thereby providing a decolorized first solid fraction and a first liquid fraction;
(iii) separating the first solid fraction from the first liquid fraction;
(iv) adding a solvent to the first solid fraction and heating the mixture at a temperature between 170-190 degrees Celsius, preferably within the range of 175-185 degrees Celsius, even more preferably at about 180 degrees Celsius, thereby providing a second solid fraction comprising the natural fibers, and a second liquid fraction comprising polyester;
(v) separating the second liquid fraction from the second solid fraction; and
(vi) separating the polyester fraction from the second liquid fraction, thereby providing a solid polyester fraction.

In one or more embodiments, the solvent is selected from the group consisting of dihydrolevoglucosenone, dimethyl sulfoxide, methyl-sulfonyl-methane, sulfolane, 4-valerolactone, 6-hexanolactone, methyl 5-(dimethylamino)-2-methyl-5-oxopentanoate, 2-Hydroxy-N,N-dimethylpropanamide, isosorbide dimethyl ether, 1,3-Dioxolane-4-methanol, 1,3-dioxane-5-ol, succinic acid dimethyl ester, glycerol diacetate, N,N-dimethyloctanamide, diethylglutarate, ethyl benzoate, 1,2-propanediol carbonate, methyl 5-(dimethylamino)-2-methyl-5-oxopentanoate, diethylene glycol monobutyl ether, diethyl adipate, benzyl alcohol, butyl benzoate, butyl 3-hydroxybutyrate, dipropylene glycol mono N-butyl ether, dipropylene glycol, propylene glycol phenyl ether, 2-phenoxy ethanol, hexylene glycol, cyclademol, CH₃O₂C(CH₂)ₙCO₂CH₃, where n=2, 3, or 4, or a combination thereof.

The apparatus may in one or more embodiments be used in a process for providing at least one solid fraction from a colored textile product comprising a naturalfiber and/or a synthetic fiber, the process comprising the steps of:
(i) proving the colored textile product comprising a natural fiber and/or one or more synthetic fibers;
(ii) adding a liquid solution of dihydrolevoglucosenone and/or derivatives of dihydrolevoglucosenone in water, thereby providing a decolorized textile product;

separating the decolorized textile product from the liquid fraction, thereby providing the at least one solid fraction.

The apparatus may in one or more embodiments be used in a process for providing at least one solid fraction from a textile product comprising a natural fiber and/or a synthetic fiber, the process comprises the steps of:
(i) providing the textile product comprising a natural fiber and/or one or more synthetic fibers;
(ii) performing a first decolorization step of adding a liquid solution of a first decolorizing agent in water to the textile product; thereby providing a first decolorized textile product;
(iii) separating the first decolorized textile product from a color-fraction;
(iv) performing a second decolorization step of adding a second decolorizing agent comprising an aprotic solvent to the textile product, thereby providing a second decolorized textile product; and
(v) separating the second decolorized textile product from a color-fraction, thereby providing the at least one solid fraction;

wherein the first decolorizing agent in the first decolorization step (ii) is an aqueous solution of a water-soluble salt of dithionous acid.

In one or more embodiments, the reactor further comprises a horizontal inlet for solvent positioned between the first filter and the second filter for pushing solvent into the reaction volume, wherein the horizontal inlet for solvent may be positioned radially or tangentially. Preferably, the horizontal inlet(s) for solvent is (are) positioned in proximity to the first filter and/or to the second filter, which means that the horizontal inlet(s) is (are) positioned in such a short distance from either the first or the second filter that the solvent flow may clean material away from the filter. The apparatus may further comprise means, such as a pump, configured for controlling the amount of solvent let into the reactor through the horizontal inlet(s) for solvent.

Another aspect relates to a process for treating textile fibres in a reactor, wherein
fiber material is fed to a reactor volume having an upper and a lower end, and the reactor volume is limited by a first filter in a lower end of the reactor volume and a second filter in the upper end of the reactor volume, and
a flow of solvent is led through the reactor volume entering the reactor volume through the first filter and exiting the reactor volume through the second filter.

The temperature in the reactor may in some embodiments be controlled by controlling at least a part of the flow of solvent added to the reactor e.g., by increasing the temperature of at least a part of the flow of solvent entering the reactor.

Yet another aspect of the present invention relates to the use of an apparatus according to the present invention to decolor or otherwise clean or treat textile material, such as textile fibers or shredded or otherwise finely divided textiles.

The apparatus for treating textiles may in some embodiments be used to chemically modifying textile fibers, e.g., to derivatize the textile fibers on a molecular level by group addition. One such example could be by adding urea to a cellulose solution in a suitable solvent. Urea reacts with the hydroxy groups of the textile fibers (the cellulose fibers), resulting in ammonia (by-product) and cellulose carbamate. Another example could be the process of making the intermediate cellulose Xanthate for viscose Rayon. Here, CS2 is added to cellulose in alkali solution. The aspect of chemically modifying textile fibers could e.g., be to enhance dissolution for separation, adding thermoplastic abilities, or change the fiber's strength properties. Other known derivatives could be methyl cellulose, cellulose acetate, ethyl cellulose, and hydroxyethyl cellulose. Another application could be to change the molecular weight of the textile fibers. For cellulose fibers, this could e.g., be done with acid treatment, or enzymatically by cellulases, preferable rich on endo-cellulase.

Still another aspect of the present invention relates to the use of an apparatus according to the present invention to chemically modify textile fibers.

### BRIEF DESCRIPTION OF THE DRAWINGS

FIG. 1 shows a first embodiment of an apparatus according to the invention,

FIG. 2 shows a second embodiment of an apparatus according to the invention.

### DETAILED DESCRIPTION OF EMBODIMENTS

### Definitions

Prior to discussing the present invention in further details, the following terms and conventions will first be defined:

In general—indicates that the features listed after this expression may be used in all embodiments of the invention.

However, it should be noted that embodiments and features described in the context of one of the aspects of the present invention also apply to the other aspects of the invention unless it is particularly pointed out that the feature may only be used in the context of one or a limited number of aspects.

The invention will now be described in further details in the following non-limiting examples.

The invention relates to an apparatus used for treating fiber material, such as textiles normally in form of shredded or otherwise finely divided textiles. The textile product may be shredded to smaller pieces. Preferably the smaller pieces of textile product may be below approximately 10×10 cm, such as below 5×5 cm, e.g., below 1×1 cm. The textiles are treated in a solvent and are kept in a solvent suspension inside a reaction volume RV.

The solvent may be any liquid, which can provide a suitable phase for dissolving a component or reacting with a component of the fiber material. Suitable examples of solvents may be as discussed above.

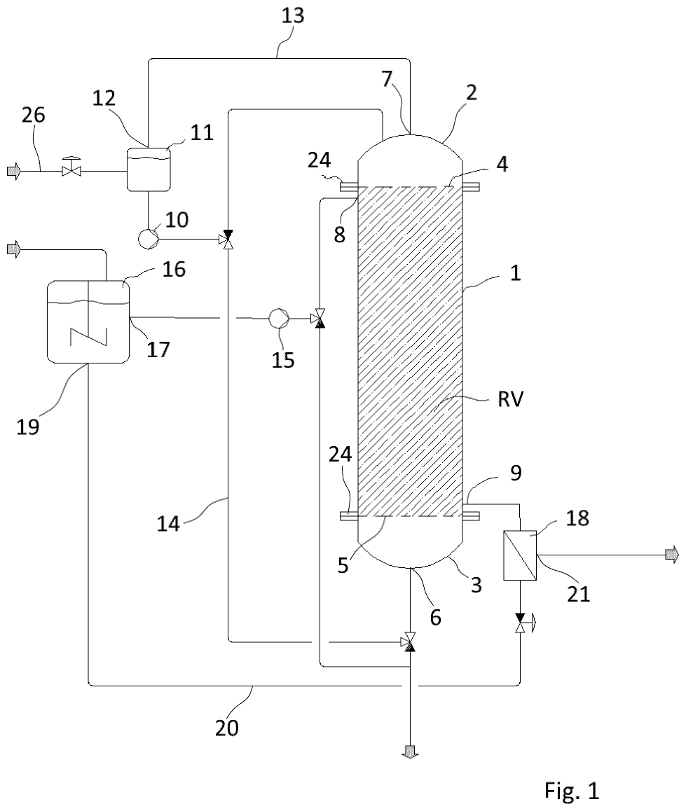

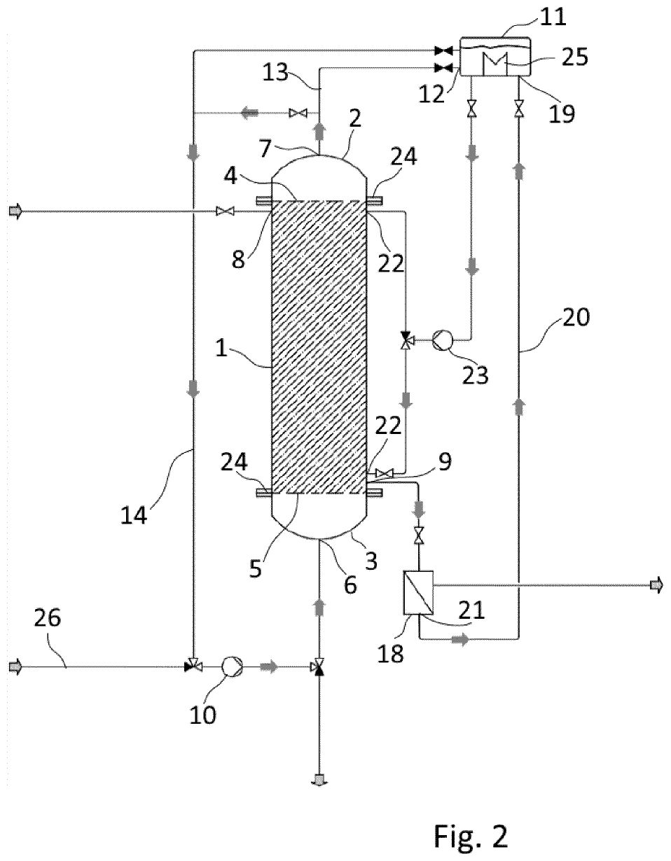

FIG. 1 shows a first embodiment of an apparatus according to the invention in which apparatus it is possible to perform a continuous process with a continuous feed of fiber material and of solvent. FIG. 2 shows a second embodiment of an apparatus according to the invention in which apparatus it is possible to perform a batch process where a portion of fiber material is added to the reaction volume RV before or after solvent is added. The solvent is normally continuously circulated through reaction volume RV in both embodiments. Identical features or features having identical functions are referred to by same reference numbers in the two embodiments shown.

An apparatus according to the invention comprises a reactor 1, which reactor 1 comprises the following features:
A lower end 3 and an upper end 2.
A first filter 5 positioned near the lower end 3 and a second filter 4 positioned near the upper end 2. The distance between the first filter 5 and the second filter 4 defines a reaction volume (RV) in which volume treatment of the textile fibers takes place. The size of the reaction volume is beside the distance between the first and second filters 5, 4, which filters define a bottom and a top of the reaction volume, determined by the inner cross-section of the reactor housing. The desired or necessary size of the reaction volume will depend on the type and amount of textile material to be treated and the solvent being used. The purpose of filters is to retain the fiber material in the reaction volume without leaving with the flow. The filters may comprise or be constituted of polymeric filter material, cellulose filter, metal mesh and/or perforated plates.
An inlet for solvent 6 positioned below the first filter 5 i.e., outside the reaction volume, and an outlet for solvent 7 positioned above the second filter 4 i.e., also outside the reaction volume. Because the outlet for solvent 7 is positioned outside the reaction volume the risk of polluting the solvent flow with textile fibres is reduced or removed. The inlet for solvent 6 is positioned below the reaction volume in order to provide a proper distribution of the up-flow of solvent making it possible for the up-flow to remove the falling textile material from packing on the first filter 5. In general, the reactor 1 is constructed with a cross-sectional shape and dimension making it possible to maintain an upward solvent flow rate vᵤ, which is at least 0.6·v_{d}, where “v_{d}” is the average downward rate of fiber sedimentation, preferably the ratio is between 0.8-1.5.

$$\frac{{v}_{u}}{{v}_{d}}$$

An inlet for fiber material 8 positioned below and normally in proximity of the second filter 4 and an outlet for suspended or wetted fiber material 9 positioned above and normally in proximity of the first filter 5. The position of the inlet and the outlet for fiber material as well as the numbers of inlets and outlets of fiber material may depend on the type of reactor and process used for the treatment. If the process is a batch process, the fiber material may be added before the solvent and the inlet for fiber material may therefore be positioned anywhere suitable for the feeding equipment, but if the process is a continuous process where fiber material is added while the reactor 1 is filled with solvent and the material falls down through the reaction volume, the fiber material should be fed into the upper end of reaction volume, preferably in proximity of the second filter 4.

During operation, solvent is forced through the reactor 1 from the inlet for solvent 6 near the bottom of the reactor 1 to the outlet for solvent 7 near the top of the reactor 1, and the fiber material is moved from the inlet for fiber material 8 normally near the top of the reactor 1 to the outlet for suspended fiber material 9 which is normally near the bottom of the reactor 1. This means that the reaction or treatment takes place in counter-current flows if no other stirring or flow creating means are used.

The first and second filters 5, 4 may be fixed relative to the reactor housing by flanges 24. The flanges 24 may be formed of surfaces of two neighboring parts of the reactor housing facing each other which surfaces are forced together e.g., when the reactor 1 is in use and which surface may be provided with or comprise a gasket material.

An apparatus according to the invention may also comprise a solvent pump 10 which pumps solvent from a solvent supply to the inlet for solvent 6 in the reactor 1. Optionally, the solvent supply is a buffer or balance tank 11 which tank beside storage of solvent may also comprise cleaning or otherwise conditioning of the solvent.

A buffer or balance tank 11 for solvent may comprises an inlet for solvent 12 which inlet 12 may be connected to the outlet for solvent 7 from the reactor 1 by a conduit (13) and to the inlet for solvent 6 by a conduit 14. This connecting makes it possible to re-circulate the solvent inside the apparatus which is highly advantageous when the solvent is either expensive to purchase and/or expensive to get rid of as waste.

The apparatus of the first embodiment of FIG. 1 comprises a fiber material feed pump 15. In general, use of a fiber material feed pump 15 is advantageous when the fiber material feed is pre-treated e.g., in a fiber preparation tank 16 where the fiber material is wetted or broad into a suspension which makes it possible to pump the suspended fiber material to the inlet for fiber material 8 of the reactor 1.

The fiber preparation tank 16 may have an inlet for dry or wetted fibres and an outlet for suspended or pumpable fiber material 17. Also, the fiber preparation tank 16 may have an inlet for dry fiber material and an inlet for solvent or another wetting fluid, i.e., the fluid used for suspending or wetting of the fiber material need not be identical to the solvent.

Normally, an apparatus according to the invention comprises one or more separation units 18 positioned downstream of the outlet for suspended or wetted fiber material 9. The separation unit(s) 18 separates or separate a fiber rich fraction from a solvent fraction and the separation unit 18 may be of any suitable kind found by anyone skilled in prior art. Some solution may found among possibilities including decanter centrifuge, dewatering screw press, drum filter, belt filtration, basket filter etc. For polymeric liquid fraction it can be transferred to a unit operation such as a thermal quenching, antisolvent addition followed by filtration.

According to an embodiment of the invention, the buffer or balance tank 11 or the fiber preparation tank 16 may have an inlet for re-used solvent 19 connected to the outlet for suspended or wetted fiber material 9 through a conduit 20. E.g., such a conduit 20 may be connected to the outlet 21 of a separation unit 18 positioned downstream of the outlet for suspended fiber material 9. This feature makes it possible to re-circulate the solvent to a tank 11, 16 where it is possible to condition, clean or modify the solvent before returning the used solvent to the reactor 1.

In general, an apparatus according to the invention may comprise a heat conditioning unit 25 which is able to control the temperature inside the reactor volume RV to maintain a desired operation temperature. According to one embodiment, the heat conditioning unit 25 controls the temperature of a flow of solvent which flow of solvent after heat conditioning is fed to the reaction volume RV. Normally, conditioning of the temperature means that the temperature of inside the reaction volume RV is increased compared to ambient temperature, e.g., to a temperature above 50° C., or e.g., to a temperature above 100° C., or e.g., to a temperature above 130° C. Alternatively, the heat conditioning unit 25 may comprise a heat exchanging shell or surface of the reactor housing heating or cooling the reaction volume RV by e.g., electricity or a water flow.

The reactor 1 may comprise one or more horizontal inlet(s) for secondary solvent 22 positioned between the first filter 5 and the second filter 4 forcing solvent into the reaction volume RV. Such horizontal inlet(s) for solvent 22 may be directed radially i.e., directed toward the center of the reaction volume RV, or tangentially i.e., the inlet flow is tangentially and provides a swirling motion of the suspension inside the reaction volume RV, or any angle between radial and tangential.

The horizontal inlet(s) for solvent 22 may be positioned in proximity to the first filter 5 and/or in proximity to the second filter 4, where “proximity” means that the horizontal inlet(s) 22 are positioned so close to either the first or the second filter 5, 4 that the solvent flow may influence deposition on and compaction near the filter and clean or loosen material near the filter.

An apparatus according to the invention may comprise means such as a pump 23 controlling the amount of secondary solvent let into the reaction volume RV through the horizontal inlet(s) for solvent 22.

The steps taking place when starting up, during operation and when closing down may vary due to the embodiment of the apparatus. The following example relates to a process performed in an apparatus as illustrated in FIG. 2 which apparatus is intended for batch operation:

### Step 1: Solvent Feed

The solvent can be fed either at process temperature or at ambient temperature, before or after the fiber material is added to the reaction volume. A valve is opened to allow fresh solvent to be pumped into the reactor by the solvent pump 10. The pump 23 controlling inlet of secondary solvent may also be turned on to fill internal piping.

### Step 2: Fiber Feed

The reaction volume RV is filled with fiber material.

Fiber may be entered into the reactor before or after the system has been filled with solvent. Also, it is possible to dose the fiber material together with solvent feed.

### Step 3: Solvent/Solution Circulation

After filling the reactor with solvent and fiber material, the heating unit is turned on, and solvent may be circulated through the reactor until the desired temperature is reached.

Once the desired temperature is reached, the heating is adjusted to maintain the desired temperature and only making up for heat loss.

Re-circulation of solvent is maintained until the fibers of the fiber material reach a desired consistency, and dissolution of dyes or polymeric fraction has occurred.

### Step 4: Fiber Purging

The fibers are pushed into the separation unit by turning on the pump 23, and then the separation unit 18 is emptied. At last, the pump 23 is turned off.

The liquid level of the system may be practically the same during this step.

### Step 5: Solvent Purging

This can be done before or after a system cooling depending on solvent/solution destination. The solvent is purged for reuse, downstream regeneration or discharged as waste.

| Ref. no. | Ref. name |
|---|---|
| 1 | Reactor |
| 2 | Upper end of reactor |
| 3 | Lower end of reactor |
| 4 | Second filter |
| 5 | First filter |
| 6 | Inlet for solvent to reactor |
| 7 | Outlet for solvent from reactor |
| 8 | Inlet for fiber material |
| 9 | Outlet for suspended or wetted fiber material |
| 10 | Solvent pump |
| 11 | Buffer or balance tank for solvent |
| 12 | Inlet for solvent to buffer/balance tank |
| 13 | Conduit for solvent between outlet of reactor |
| | and buffer/balance tank |
| 14 | Conduit for solvent between buffer/balance tank |
| | and inlet of reactor |
| 15 | Fiber material feed pump |
| 16 | Fiber preparation tank |
| 17 | Outlet for fiber material from fiber preparation tank |
| 18 | Separation unit |
| 19 | Inlet for used solvent |
| 20 | Conduit between separation unit and fiber preparation |
| | tank (FIG. 1) or buffer/balance tank (FIG. 2) |
| 21 | Outlet of separation unit |
| 22 | Horizontal inlet to reactor |
| 23 | Pump controlling inlet of secondary solvent |
| 24 | Flanges |
| 25 | Heat conditioning unit |
| 26 | Fresh feed |
| RV | Reaction Volume |

1. Apparatus for treating textile fibers in a solvent suspension comprising a reactor (1), wherein the reactor (1) comprises
a lower end (3) and an upper end (2),
a first filter (5) positioned near the lower end and a second filter (4) positioned near the upper end, the distance between the first filter (5) and the second filter (4) defines a reaction volume for treatment of the textile fibers,
an inlet for solvent (6) positioned below the first filter (5),
an outlet for solvent (7) positioned above the second filter (4),
an inlet for fiber material (8) positioned below and normally in proximity of the second filter (4), and
an outlet for suspended or wetted fiber material (9) positioned above and normally in proximity of the first filter (5),
where solvent is forced through the reactor (1) from the inlet for solvent (6) to the outlet for solvent (7), and the fiber material is moved from the inlet for fiber material (8) to the outlet for suspended fiber material (9).

2. The apparatus according to claim 1, further comprising a solvent pump (10) adapted for pumping solvent to the inlet for solvent (6), optionally from a buffer or balance tank (11).

3. The apparatus according to claim 2, further comprising:
a buffer or balance tank (11) for solvent, and
an inlet for solvent (12) for connection to the outlet for solvent (7) from the reactor (1) by a conduit (13) and for connection to the inlet for solvent (6) by a conduit (14).

4. The apparatus according to claim 1, further comprising a fiber material feed pump (15) adapted for pumping suspended fiber material to the inlet for suspended fiber material (8).

5. The apparatus according to claim 1, further comprising a fiber preparation tank (16) having an inlet for dry or wetted fibers and an outlet (17) for suspended or pumpable fiber material.

6. The apparatus according to claim 1, further comprising a separation unit (18) positioned downstream of the outlet for suspended or wetted fiber material (9), which separation unit (18) separates a fiber rich fraction from a solvent fraction.

7. The apparatus according to claim 1, wherein either a buffer or balance tank (11) or a fiber preparation tank (16) has an inlet for re-used solvent (19) connected to the outlet for suspended or wetted fiber material (9) through a conduit (20), preferably the conduit (20) is connected to the outlet of a separation unit (21) positioned downstream of the outlet for suspended fiber material (9).

8. The apparatus according to claim 1, further comprising a heat conditioning unit (25) configured to regulate temperature of the solvent in the reactor (1) to a temperature above ambient temperature.

9. The apparatus according to claim 1, wherein the reactor (1) comprises a horizontal inlet for solvent (22) positioned between the first filter (5) and the second filter (4) for pushing solvent into the reaction volume, wherein the horizontal inlet for solvent (22) may be positioned radially or tangentially.

10. The apparatus according to claim 9, wherein the horizontal inlet for solvent (22) is positioned in proximity to the first filter (5) or to the second filter (4), which means that the horizontal inlet is positioned at a distance from either the first filter (5) or the second filter (4) such that the solvent flow cleans material away from the filter.

11. The apparatus according to claim 9, further comprising means, such as a pump (23), configured for controlling the amount of solvent let into the reactor (1) through the horizontal inlet for solvent (22).

12. A process for treating textile fibers in a reactor, wherein
fiber material is fed to a reactor volume having an upper and a lower end, and the reactor volume is limited by a first filter in a lower end of the reactor volume and a second filter in an upper end of the reactor volume, and
a flow of solvent is led through the reactor volume entering the reactor volume through the first filter and exiting the reactor volume through the second filter.

13. A process according to claim 12, wherein the temperature in the reactor is controlled by controlling at least a part of the flow of solvent added to the reactor by increasing the temperature of at least a part of the flow of solvent entering the reactor.

14. A process for using an apparatus according to claim 1 to decolor or otherwise clean or treat textile material, such as textile fibers or shredded or otherwise finely divided textiles.

15. A process for using an apparatus according to claim 1 to chemically modify, e.g., by addition reactions, textile fibers.
